(19) United States
(12) Patent Application Publication
(10) Pub. No.: US 2012/0196549 A1
(43) Pub. Date: Aug. 2, 2012

(54) COMMUNICATION DEVICE

(75) Inventors: CHO-KANG HSU, Tu-Cheng (TW); CHIA-HUNG SU, Tu-Cheng (TW); SHIH-TSUNG KAN, Tu-Cheng (TW); CHIA-MING LIANG, Tu-Cheng (TW)

(73) Assignee: CHI MEI COMMUNICATION SYSTEMS, INC., Tu-Cheng (TW)

(21) Appl. No.: 13/095,005

(22) Filed: Apr. 27, 2011

(30) Foreign Application Priority Data
Jan. 28, 2011 (TW) 100103214

(51) Int. Cl. H04B 1/38

(52) U.S. Cl. 455/90.2

(57) ABSTRACT

A communication device includes a first antenna, a second antenna, a power splitter, a switch, and a sensor. The power splitter is electronically connected to the first antenna and the second antenna. The switch is connected to the first antenna and the power splitter. The sensor is installed near the first antenna and may sense a user's body within close proximity. The sensor generates an interrupt signal when sensing a user's body within close proximity. The switch is electronically connected to the power splitter rather than the first antenna in response to the interrupt signal. The switch is electronically connected to the first antenna rather than the power splitter when the interrupt signal is terminated.

### BACKGROUND

1. Technical Field

The present disclosure relates to a communication device and an antenna management method thereof.

2. Description of Related Art

Specific absorption rate (SAR) is a measure of the rate at which energy is absorbed by the user's body when exposed to a radio frequency (RF) electromagnetic field. SAR of communication devices must conform to SAR regulations of the countries they are sold or used in. In order to reduce the SAR of communication devices, the total radiated power (TRP) of the communication devices is generally reduced. However, the antenna performance of the communication devices may suffer as a result.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding portions throughout the figures.

FIG. 1 is a block diagram of an exemplary embodiment of a communication device.

FIG. 2 is a flowchart illustrating an exemplary embodiment of an antenna management method of a communication device.

### DETAILED DESCRIPTION

In general, the word “module” as used herein, refers to logic embodied in hardware or firmware, or to a collection of software instructions, written in a programming language, such as, for example, Java, C, or Assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as software and/or a hardware unit and may be stored in any type of computer-readable medium or other computer storage device.

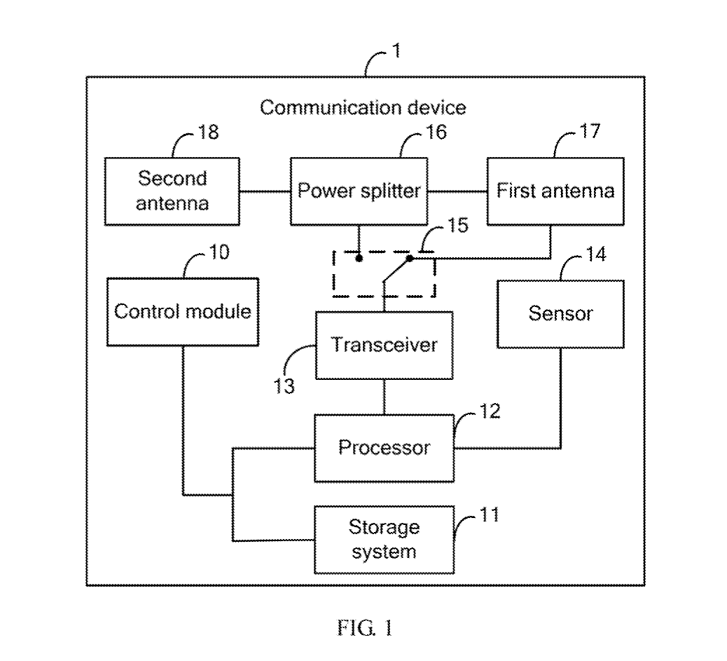

FIG. 1 is a block diagram of an exemplary embodiment of a communication device 1. The communication device 1 may be a mobile phone, a personal digital assistant, or a mobile Internet device, for example. The communication device 1 includes a control module 10, a storage system 11, a processor 12, a transceiver 13, a sensor 14, a switch 15, a power splitter 16, a first antenna 17, and a second antenna 18.

The control module 10 may include computerized code in the form of one or more programs stored in the storage system 11. The computerized code includes instructions that are executed by the processor 12 to provide functions for the control module 10. The sensor 14 may be a capacitive sensor, an electric field sensor, or a proximity sensor, for example.

The first antenna 17 and the second antenna 18 transmit and receive wireless signals. The power splitter 16 is electronically connected to the first antenna 17 and the second antenna 18. The switch 15 is connected to the first antenna 17 and the power splitter 16. In this exemplary embodiment, the switch 15 is initially electronically connected to the first antenna 17 when the communication device 1 is turned on. The transceiver 13 is electronically connected to the power splitter 16 or the first antenna 17 via the switch 15.

The sensor 14 is installed near the first antenna 17 and senses a user's body within close proximity. The sensor 14 generates an interrupt signal when sensing a user's body within close proximity. The control module 10 electronically connects the switch 15 to the power splitter 16 rather than the first antenna 17 in response to the interrupt signal. The power splitter 16 splits radio frequency (RF) power to the first antenna 17 and the second antenna 18 by a preset ratio. The transceiver 13 transmits or receives wireless signals via the first antenna 17 and the second antenna 18 when the switch 15 is electronically connected to the power splitter 16.

When the sensor 14 does not sense a user's body within close proximity anymore, the interrupt signal is terminated. The control module 10 then electronically connects the switch 15 to the first antenna 17 rather than the power splitter 16. The transceiver 13 transmits or receives wireless signals via the first antenna 17 when the switch 15 is electronically connected to the first antenna 17.

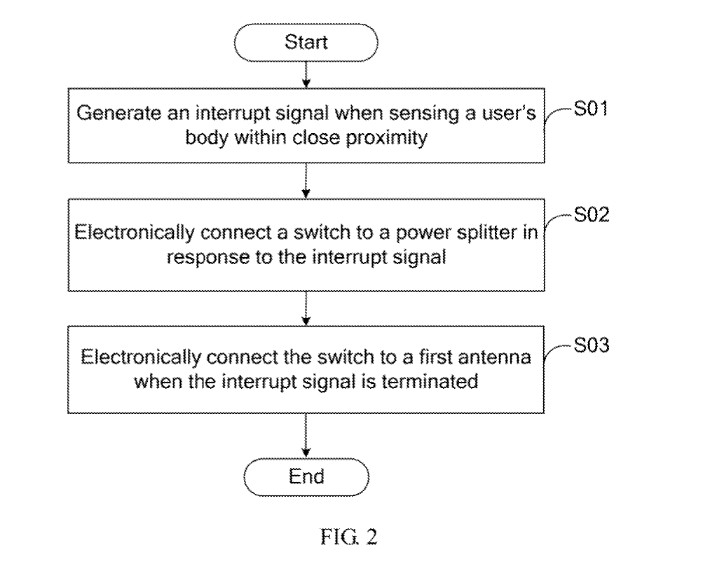

FIG. 2 is a flowchart illustrating an exemplary embodiment of an antenna management method of the communication device 1. Depending on the exemplary embodiment, additional blocks may be added, others removed, and the ordering of the blocks may be changed.

In block S01, the sensor 14 generates the interrupt signal when sensing a user's body within close proximity.

In block S02, the control module 10 electronically connects the switch 15 to the power splitter 16 rather than the first antenna 17 in response to the interrupt signal.

In block S03, the control module 10 electronically connects the switch 15 to the first antenna 17 rather than the power splitter 16 when the interrupt signal is terminated.

The present disclosure provides a communication device including a first antenna and a second antenna. When a user's body is close to the first antenna, the communication device can distributively transmit or receive wireless signals via the first antenna and the second antenna. As a result, electromagnetic energy of the communication device absorbed by the user's body can be reduced.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of portions within the principles of the present invention to the full extent indicated by the broad general meaning of the terms in which the appended claims are expressed.

What is claimed is:

1. A communication device, comprising:
a first antenna;
a second antenna;
a power splitter electronically connected to the first antenna and the second antenna;
a switch connected to the first antenna and the power splitter;
a transceiver electronically connected to the first antenna or the power splitter via the switch;
a sensor installed near the first antenna and configured to sense a user's body within close proximity;
at least one processor;
a storage system; and
one or more programs stored in the storage system and being executable by the at least one processor, the one or more programs comprising a control module;
wherein the sensor generates an interrupt signal when sensing a user's body within close proximity; and
wherein the control module electronically connects the switch to the power splitter rather than the first antenna in response to the interrupt signal.

2. The communication device of claim 1, wherein the control module electronically connects the switch to the first antenna rather than the power splitter when the interrupt signal is terminated.

3. The communication device of claim 2, wherein the transceiver transmits or receives wireless signals via the first antenna when the switch is electronically connected to the first antenna.

4. The communication device of claim 1, wherein the transceiver transmits or receives wireless signals via the first antenna and the second antenna when the switch is electronically connected to the power splitter.

5. A computer-implemented antenna management method of a communication device, the communication device comprising a first antenna, a second antenna, a power splitter electronically connected to the first antenna and the second antenna, a switch connected to the first antenna and the power splitter, and a sensor installed near the first antenna, the method comprising:
generating an interrupt signal when the sensor senses a user's body within close proximity; and
electronically connecting the switch to the power splitter rather than the first antenna in response to the interrupt signal.

6. The method of claim 5, further comprising:
electronically connecting the switch to the first antenna rather than the power splitter when the interrupt signal is terminated.
